(19) United States
(12) Patent Application Publication
(10) Pub. No.: US 2022/0333395 A1
(43) Pub. Date: Oct. 20, 2022

(54) UNDERWATER TIME-OF-FLIGHT SENSING SYSTEMS PRINCIPALLY FOR USE IN CONNECTION WITH SWIMMING POOLS OR SPAS

(71) Applicant: ZODIAC POOL CARE EUROPE, Belberaud (FR)

(72) Inventors: Mehdi Chafik, Tournefeuille (FR); Phillip Newman, Kya Sand (ZA)

(73) Assignee: ZODIAC POOL CARE EUROPE, Belberaud (FR)

(21) Appl. No.: 17/720,015

(22) Filed: Apr. 13, 2022

Related U.S. Application Data
(60) Provisional application No. 63/175,395, filed on Apr. 15, 2021.

(51) Int. Cl. E04H 4/16; G01S 17/42; G01S 17/93; G01S 7/481

(52) U.S. Cl. CPC E04H 4/1654; G01S 17/42; G01S 17/93; G01S 7/4813

(57) ABSTRACT

Automatic swimming pool cleaners may include time-of-flight sensors. The sensors may operate underwater and transmit and receive light radiation. They may be useful especially in providing distance and angular information relating to location of a pool cleaner relative to a wall of, or object within, a pool. The automatic swimming pool cleaner may be controlled based on the sensed information from the time-of-flight sensors

### REFERENCE TO RELATED APPLICATION

This application claims the benefit of U.S. Provisional Patent Application No. 63/175,395, filed on Apr. 15, 2021 and entitled UNDERWATER TIME-OF-FLIGHT SENSING SYSTEMS PRINCIPALLY FOR USE IN CONNECTION WITH SWIMMING POOLS OR SPAS, the content of which is hereby incorporated by reference in its entirety.

### FIELD OF THE INVENTION

This invention relates to equipment principally for use in connection with water-containing vessels such as swimming pools and spas and more particularly, but not necessarily exclusively, to equipment, systems, and methods employing time-of-flight (“ToF”) sensors during operation of automatic swimming pool cleaners (“APCs”) within the vessels.

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

International Patent Application Publication No. WO 2020/041075 of Newman, et al. (the “Newman PCT Application”), whose contents are incorporated herein in its entirety by this reference, describes mapping and tracking methods and systems for use in connection with pools and spas. Included as part of these systems may be an apparatus for light detection and ranging (“LIDAR”) having a rotating ToF sensor. The sensor projects above the waterline of a pool “so as to send laser light through air, rather than water,” and the apparatus may be tethered to an APC travelling within the pool. In use, the ToF sensor “collects data as it scans the walls forming the perimeter of a pool at and above the waterline.”

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a ToF sensor is attached on, in, or carried by, an APC.

According to some embodiments, an APC includes a ToF sensor and a controller that uses information from the ToF sensor to determine a distance from a wall, floor, or object or angular information relating to a wall, floor, or object.

According to various embodiments, a method of cleaning a swimming pool includes placing an APC in water of the swimming pool and using information obtained by a ToF sensor attached on, in, or to, or carried by, the APC.

According to some embodiments, an APC includes a submergible ToF sensor.

According to certain embodiments, an APC includes a ToF sensor that transmits and/or receives light.

According to some embodiments, a method of cleaning a swimming pool includes controlling an APC while the APC is underwater based on information obtained by an underwater ToF sensor attached on, in, or carried by, the APC.

According to various embodiments, an APC includes a ToF sensor, and the ToF sensor includes a PCB, at least one emitter on the PCB, and at least one receiver on the PCB. The PCB may absorb light at certain wavelengths.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an APC according to embodiments.

FIG. 2 illustrates a ToF sensor on a portion of the APC of FIG. 1 according to embodiments.

### DESCRIPTION OF THE INVENTION

Described herein are systems and methods of employing a ToF sensor underwater, and particularly, but not limited to, connection with the use of robotic APCs. Sensed information from the underwater ToF sensor may be used by the APC to perform various actions or controls as desired. As an example, sensed information may be utilized to measure distance from an APC to a pool wall, stairs, or an obstacle within a pool, for example. This information may allow the APC to avoid unnecessarily contacting the wall. As another example, the sensed information also may allow for detection of a wall before climbing, and without any need to climb, the wall. Sensed information further may include data concerning an angle at which an APC is moving toward or away from a wall. Angular details further may be useful in orienting the APC so that it travels either parallel or tangent to a wall, essentially “following” the wall to clean areas adjacent the bottom of the wall. Yet additionally, sensed information may include distance from an APC to the floor or other bottom of a pool. Such information may be particularly useful when the APC is climbing a generally vertical pool wall and potentially may be useful in deducing the depth of the pool, for example. It also may be used to assess when the APC is approaching the pool waterline so as to reduce the likelihood of the APC breaching the water surface and ingesting air. Conventionally, ToF sensors transmit and receive infrared radiation. By contrast, at least some ToF sensors of the present invention may use visible light. Transmitting and receiving light in the visible spectrum may be advantageous, especially in the relatively clear water of swimming pools and spas. In other embodiments, the ToF sensor may include any light, whether visible to the human eye or not. In certain embodiments, the ToF sensor may have a fixed or predetermined sensing region relative to a body of the APC. Various other benefits and advantages may be realized with the systems and methods provided herein, and the aforementioned advantages should not be considered limiting.

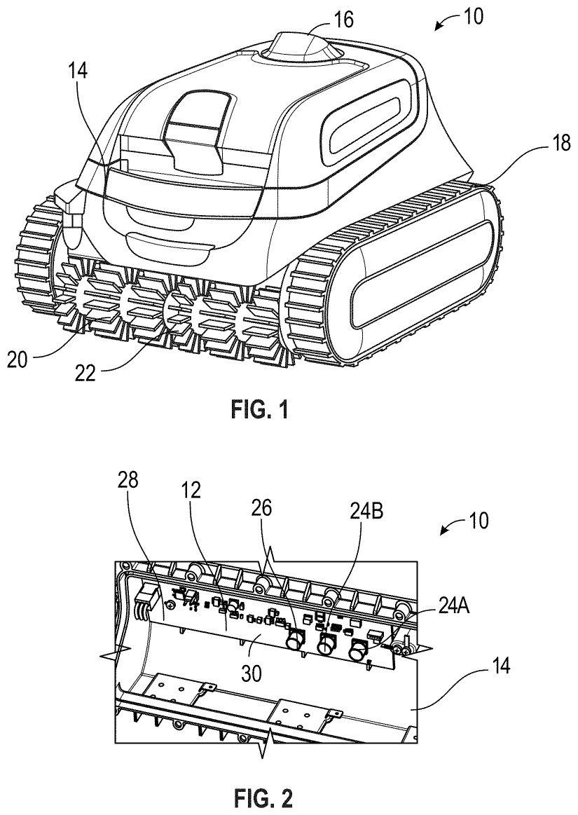

FIG. 1 illustrates an example of an APC 10 that may include a ToF sensor 12 according to embodiments. The APC 10 may include a body 14 having a water inlet, a water outlet 16, a propulsion system 18 (e.g., wheels, tracks, and/or other motive elements), a vacuum system (e.g., a pump), a controller (e.g., a processor and/or memory), optional cleaning components 20 (e.g., brushes 22), a motor, and a filter, among other components. In such embodiments, similar to the ToF sensor 12, the controller may be provided on, in, or at various locations relative to the APC 10 as desired. The particular APC 10 illustrated in FIG. 1 should not be considered limiting, and the ToF sensor 12 may be used in various other types of APCs as desired with fewer, additional, or other combinations of components or features. As an example, the Newman PCT Application schematically illustrates another exemplary APC. Moreover, while the ToF sensor 12 is discussed in the context of the APC 10, in other embodiments, the ToF sensor 12 may be provided on equipment other than APCs.

FIG. 2 illustrates the ToF sensor 12 on a portion of the body 14 of the APC 10. The particular location of the ToF sensor 12 on the APC 10 should not be considered limiting, and in certain embodiments, one or more ToF sensors 12 may be attached to or integrated into various locations relative to the APC 10 as desired, including locations on the APC, locations in the APC, locations carried by the APC 10, locations remote from the APC 10 but underwater and tethered to the APC 10 (e.g., using a cable, tether, etc.), combinations thereof, and/or other locations as desired. In certain embodiments, the ToF sensor 12 may have a fixed or predetermined sensing region relative to the body 14 of the APC 10 (e.g., the ToF sensor 12 is configured to “look” in a same direction relative to the body 14 of the APC 10, and the ToF sensor 12).

As illustrated in FIG. 2, the ToF sensor 12 includes one or more emitters 24 and one or more receivers 26. In the embodiment of FIG. 2, the ToF sensor 12 includes two emitters 24A-B and one receiver 26. The one or more emitters 24 and the one or more receivers 26 may be various suitable types of emitters 24 and receivers 26 for sending and receiving signals underwater for sensing ToF. As one non-limiting example, the ToF sensor 12 may transmit and receive infrared radiation. As a further non-limiting example, the ToF sensor 12 advantageously may transmit and receive visible light. As mentioned, transmitting and receiving light in the visible spectrum may be advantageous, especially in the relatively clear water of swimming pools and spas.

In some embodiments, the one or more emitters 24 and/or the one or more receivers 26 may be supported on a mounting substrate 28. In some embodiments, the mounting substrate 28 may be a printed circuit board (PCB) 30. In some embodiments, the mounting substrate 28 may have various characteristics or features to improve performance of the ToF sensor 12. As an example, the mounting substrate 28 may a dark or opaque color, which may absorb light interference underwater and/or in air. In such embodiments, the mounting substrate 28 may have a dark or opaque color and/or otherwise have various properties such that the mounting substrate 28 provides low reflection and low transmissivity. In some embodiments, the mounting substrate 28 may have a reflectance of less than or equal to 0.1, although it need not be in other embodiments. In certain embodiments, the mounting substrate 28 may be configured to absorb light at certain wavelengths, which may represent measurement noise that impacts the performance of the ToF sensor 12.

While a single ToF sensor 12 is illustrated in FIG. 2, in other embodiments, the APC 10 or other equipment may include a plurality of ToF sensors 12. In such embodiments, the ToF sensors 12 may be arranged at various locations on, within, or relative to the APC 10 as desired. In certain embodiments, the ToF sensors 12 may be provided at various angles as desired, such as similar angles or different angles compared to other ToF sensors. In certain embodiments, a plurality of ToF sensors 12 may facilitate a detection or determination of various characteristics of underwater obstacles (e.g., a distance, an inclination of a wall, a height of a step, a size of an obstacle, a corner of a pool, etc.).

Information sensed by the ToF sensor 12 while underwater may be used by the APC 10 to perform various operations while the APC 10 is underwater in a pool or spa. In such embodiments, the ToF sensor 12 may be communicatively coupled with the controller such that the sensed information from the ToF sensor 12 may be provided to the controller, and the controller may perform various operations and/or cause the APC 10 to perform various operations based on the sensed information from the ToF sensor 12. As one non-limiting example, the sensed information may be used by the APC 10 (e.g., by the controller of the APC 10) to measure a distance from the APC 10 to a wall, a floor, or other underwater obstacle. As a further non-limiting example, the sensed information may be used by the APC 10 to measure or determine an angle at which the APC 10 is moving towards or away from the wall, the floor, or other underwater obstacle.

In certain embodiments, based on the determined distance and/or angle of the APC 10 relative to an underwater obstacle, the APC 10 may control itself (e.g., by the controller of the APC 10). As a non-limiting example, the APC 10 may control itself based on the sensed information from the ToF sensor 12 to adjust a cleaning pattern of the APC 10. In certain examples, adjusting the cleaning pattern may be adjusting the APC 10 to avoid hitting one or more walls or underwater obstacles within the pool or spa. As a further non-limiting example, the sensed information from the ToF sensor 12 may allow the APC 10 to orient itself so that the APC 10 is moving at a particular angle relative to a wall. As an example of such embodiments, the APC 10 may orient itself so that the APC 10 travels at an angle that is parallel or tangent to the wall and to follow the wall (e.g., to clean the bottom of the wall all around the pool). In other embodiments, the APC 10 may orient itself to be at other angles and/or relative to other structures underwater as desired.

As another example, the controller of the APC 10 may use the sensed information from the ToF sensor 12 to determine characteristics of various underwater obstacles. As non-limiting examples, based on the sensed information from the ToF sensor 12, the APC 10 may determine an inclination of a wall of the pool and/or a size of the obstacle, among other characteristics.

As a further non-limiting example, the APC 10 may use the sensed information from the ToF sensor 12 to provide information to a customer. In such embodiments, the information need not necessarily be related to a distance or angular orientation of the APC 10. As an example, the APC 10 may provide information about filter status, power level, cleaning cycle time, and/or other information about the APC 10 as desired based on the APC 10 determining, for example, that it is within a predetermined distance from a wall.

In another non-limiting example, the APC 10 may use the sensed information to determine a distance to a floor of the pool when the APC 10 is on a wall of the pool. In such embodiments, the APC 10 may adapt a cleaning pattern based on the detected distance to the floor of the pool and/or perform other operations as desired.

As yet a further non-limiting example of control of the APC 10 based on the sensed information from the ToF sensor 12, the APC 10 may be able to detect the wall or other structure without having to climb the wall to detect it. In other words, while a typical APC may rely on a detection of vertical movement (e.g., climbing a wall) to detect a wall of the pool, the APC 10 with the ToF sensor 12 need not climb the wall to be able to detect it, which may reduce cleaning cycle time of the APC 10 because the APC 10 does not need to move between a horizontal orientation and a vertical orientation.

As another non-limiting example of control of the APC 10 based on sensed information from the ToF sensor 12, the APC 10 may be able to detect another object's movement relative to the APC 10. As an example, the APC 10 may detect the object, and if a rate of change of distance between the APC 10 and the object is different from what is expected based on the speed of the APC 10, the APC 10 may determine that the object is moving towards or away from the APC 10.

A further non-limiting example of control of the APC 10 based on the sensed information from the ToF sensor 12 may include detecting a slope of a surface. In such embodiments, the APC 10 may use a sensor aiming forward and another sensor aiming upwards at a certain angle, and the APC 10 may determine a slope based on a change in the angle.

Exemplary concepts or combinations of features of the invention may include:
A. A ToF sensor attached on, in, or to, or carried by, an APC.
B. An APC including a submergible ToF sensor.
C. The APC according to statement B, wherein the ToF sensor is configured to transmit and receive visible light underwater.
D. The APC according to statement B or C, wherein the ToF sensor is on a body of the APC or within the body of the APC.
E. The APC according to any one of statements B-D, wherein the ToF sensor is spaced apart from the APC and tethered to the APC.
F. The APC according to any one of statements B-E, further comprising a controller communicatively coupled to the ToF sensor, wherein the controller is configured to control the APC based on sensed information from the ToF sensor.
G. The APC according to any one of statements B-F, wherein, based on the sensed information from the ToF sensor, the controller is configured to determine a distance of the APC from a wall, floor, or object or angular information relating to an underwater obstacle.
H. The APC according to any one of statements B-G, wherein, based on the sensed information from the ToF sensor, the controller is configured to determine angular information of the APC relative to an underwater obstacle.
I. The APC according to any one of statements B-H, wherein the controller is configured to adjust a cleaning pattern of the APC based on the sensed information from the ToF sensor.
J. The APC according to any one of statements B-I, wherein the ToF sensor is a first ToF sensor of a plurality of ToF sensors.
K. The APC according to any one of statements B-J, further comprising a controller communicatively coupled to the plurality of ToF sensors, wherein the controller is configured determine a characteristic of an underwater obstacle based on sensed information from the plurality of ToF sensors.
L. The APC according to any one of statements B-K, wherein the ToF sensor comprises a mounting substrate, at least one emitter, and at least one receiver, and wherein the mounting substrate is configured to absorb light at certain wavelengths.
M. The APC according to any one of statements B-L, wherein the mounting substrate is a dark or opaque color with low reflection and low transmissivity.
N. An APC including a ToF sensor configured to transmit and/or receive visible light.
O. The APC according to statement N, wherein the ToF sensor is on a body of the APC or within the body of the APC.
P. The APC according to statement N or O, further comprising a controller communicatively coupled to the ToF sensor, wherein the controller is configured to control the APC based on sensed information from the ToF sensor.
Q. The APC according to any one of statements N-P, wherein, based on the sensed information from the ToF sensor, the controller is configured to determine a distance of the APC from a wall, floor, or object or angular information relating to an underwater obstacle.
R. The APC according to any one of statements N-Q, wherein, based on the sensed information from the ToF sensor, the controller is configured to determine angular information of the APC relative to an underwater obstacle.
S. The APC according to any one of statements N-R, wherein the controller is configured to adjust a cleaning pattern of the APC based on the sensed information from the ToF sensor.
T. An APC including a ToF sensor and a controller configured to use information from the ToF sensor to determine a distance from a wall, floor, or object or angular information relating to a wall, floor, or object.
U. A method of cleaning a swimming pool comprising placing an APC in water of the swimming pool and using information obtained by a ToF sensor attached on, in, or to, or carried by, the APC.
V. An APC as described in FIGS. 1 and 2.
W. A method of cleaning a swimming pool comprising controlling an APC while the APC is underwater based on information obtained by an underwater ToF sensor attached on, in, or carried by, the APC.
X. The method according to statement W, further comprising determining a distance of the APC from a wall, floor, or underwater object or determining angular information of the APC relative to the wall, floor, or underwater object.
Y. The method according to statement W or X, wherein controlling the APC comprises adjusting a cleaning pattern of the APC based on the sensed information from the ToF sensor.
Z. The method according to any one of statements W-Y, wherein the ToF sensor is a first ToF sensor of a plurality of ToF sensors, and wherein the method further comprises determining a characteristic of an underwater obstacle based on sensed information from the plurality of ToF sensors.
AA. An APC comprising a ToF sensor, the ToF sensor comprising a PCB, at least one emitter on the PCB, and at least one receiver on the PCB, wherein the PCB is configured to absorb light at certain wavelengths.
BB. The APC according to statement AA, wherein the PCB comprises a dark or opaque color with low reflection and low transmissivity.
CC. A method of providing information about an APC based information sensed by a ToF sensor of the APC.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “102A” refers to an instance of a device class, which may be referred to collectively as devices “102” and any one of which may be referred to generically as a device “102”. In the figures and the description, like numerals are intended to represent like elements. As used herein, the meaning of “a,” “an,” and “the” includes singular and plural references unless the context clearly dictates otherwise.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

That which is claimed:

1. An automatic swimming pool cleaner (APC) comprising a submergible time-of-flight (ToF) sensor.

2. The APC of claim 1, wherein the ToF sensor is configured to transmit and receive light underwater.

3. The APC of claim 1, wherein the ToF sensor is on a body of the APC or within the body of the APC.

4. The APC of claim 1, wherein the ToF sensor is spaced apart from the APC and tethered to the APC.

5. The APC of claim 1, further comprising a controller communicatively coupled to the ToF sensor, wherein the controller is configured to control the APC based on sensed information from the ToF sensor.

6. The APC of claim 5, wherein, based on the sensed information from the ToF sensor, the controller is configured to determine a distance of the APC from a wall, floor, or object or angular information relating to an underwater obstacle.

7. The APC of claim 5, wherein, based on the sensed information from the ToF sensor, the controller is configured to determine angular information of the APC relative to an underwater obstacle.

8. The APC of claim 5, wherein the controller is configured to adjust a cleaning pattern of the APC based on the sensed information from the ToF sensor.

9. The APC of claim 1, wherein the ToF sensor is a first ToF sensor of a plurality of ToF sensors.

10. The APC of claim 9, further comprising a controller communicatively coupled to the plurality of ToF sensors, wherein the controller is configured determine a characteristic of an underwater obstacle based on sensed information from the plurality of ToF sensors.

11. The APC of claim 1, wherein the ToF sensor comprises a mounting substrate, at least one emitter, and at least one receiver, and wherein the mounting substrate is configured to absorb light at certain wavelengths.

12. The APC of claim 11, wherein the mounting substrate is a dark or opaque color with low reflection and low transmissivity.

13. An automatic swimming pool cleaner (APC) comprising a time-of-flight (ToF) sensor configured to transmit and receive visible light.

14. The APC of claim 13, wherein the ToF sensor is on a body of the APC or within the body of the APC.

15. The APC of claim 13, further comprising a controller communicatively coupled to the ToF sensor, wherein the controller is configured to control the APC based on sensed information from the ToF sensor.

16. The APC of claim 15, wherein, based on the sensed information from the ToF sensor, the controller is configured to determine a distance of the APC from a wall, floor, or object or angular information relating to an underwater obstacle.

17. The APC of claim 15, wherein, based on the sensed information from the ToF sensor, the controller is configured to determine angular information of the APC relative to an underwater obstacle.

18. The APC of claim 15, wherein the controller is configured to adjust a cleaning pattern of the APC based on the sensed information from the ToF sensor.

19. A method of cleaning a swimming pool comprising controlling an automatic swimming pool cleaner (APC) while the APC is underwater based on information obtained by an underwater time-of-flight (ToF) sensor attached on, in, or carried by, the APC.

20. The method of claim 19, further comprising determining a distance of the APC from a wall, floor, or underwater object or determining angular information of the APC relative to the wall, floor, or underwater object.

21. The method of claim 19, wherein controlling the APC comprises adjusting a cleaning pattern of the APC based on the sensed information from the ToF sensor.

22. The method of claim 19, wherein the ToF sensor is a first ToF sensor of a plurality of ToF sensors, and wherein the method further comprises determining a characteristic of an underwater obstacle based on sensed information from the plurality of ToF sensors.

23. An automatic swimming pool cleaner (APC) comprising a time-of-flight (ToF) sensor, the ToF sensor comprising a printed circuit board (PCB), at least one emitter on the PCB, and at least one receiver on the PCB, wherein the PCB is configured to absorb light at certain wavelengths.

24. The APC of claim 23, wherein the PCB comprises a dark or opaque color with low reflection and low transmissivity.
